(19) United States
(12) Patent Application Publication
(10) Pub. No.: US 2023/0189835 A1
(43) Pub. Date: Jun. 22, 2023

(54) WIDGETLESS CANNED NITROGEN INFUSED BEVERAGES

(71) Applicant: Starbucks Corporation, Seattle, WA (US)

(72) Inventors: Patrick M. Penny, Seattle, WA (US); Rajesh R. Jetti, Sammamish, WA (US); Gabriela A. Gonzalez-Israel, Normandy Park, WA (US); Ruby Amegah, Sammamish, WA (US)

(21) Appl. No.: 18/052,810

(22) Filed: Nov. 4, 2022

Related U.S. Application Data
(60) Provisional application No. 63/265,764, filed on Dec. 20, 2021.

(51) Int. Cl. A23F 5/24; A23F 5/26; A23F 3/16; A23L 2/38; A23L 2/54; A23L 2/60; A23L 2/56

(52) U.S. Cl. CPC A23F 5/243; A23F 5/267; A23F 3/163; A23L 2/38; A23L 2/54; A23L 2/60; A23L 2/56; A23V 2002/00

(57) ABSTRACT

Disclosed herein are non-alcoholic nitrogen infused beverages and method for producing such beverages. The processes described herein comprise producing a mixed gas beverage supported with a foaming agent. Liquid nitrogen and carbon dioxide are added to the beverage, with the addition of a foaming agent, such as soapbark extract. In some embodiments, this process provides a nitrogen infused beverage with foaming and cascading capabilities that are equivalent to a nitro experience delivered through a widget can, without the need for the widget or the use of nitrous oxide.

### INCORPORATION BY REFERENCE TO ANY PRIORITY APPLICATIONS

This application claims the benefit of U.S. Provisional Application No. 63/265764, filed Dec. 20, 2021, and titled WIDGETLESS CANNED NITROGEN INFUSED BEVERAGES. Each of the foregoing applications is hereby incorporated by reference in their entirety. Any and all applications for which a foreign or domestic priority claim is identified in the Application Data Sheet as filed with the present application are hereby incorporated by reference under 37 CFR 1.57.

### BACKGROUND

### Field

The embodiments described herein are generally related to nitrogen-infused beverages and methods for preparing nitrogen-infused beverages.

### Description

Nitrogen infused beverages, nitro beverages, or nitro drinks, are beverages infused with nitrogen gas. Nitrogen cold brew coffee, commonly shortened to nitro, nitro coffee, or nitro cold brew, is a nitrogen infused beverage comprising coffee infused with nitrogen gas. Various processes have been employed to infuse nitrogen into beverages.

For example, when infusion is performed on relatively large quantities of beverage, such as in a keg, nitrogen may be dispensed from a tank into the keg in a way similar to that used in brewing beer. However, such configurations require bulky equipment, such as kegs, a nitrogen tank, a regulator, a refrigerator, and a tap. Furthermore, using a batch nitrogen-infusion process is time-consuming as the infusion may take 24 hours or more. Increasingly, consumers desire single-serving nitrogen-infused beverages that may be stored and enjoyed at home or purchased individually in stores. Thus, processes for packaging single-serving sealed cans of nitrogen-infused beverages have been developed.

One such process involves placement of a “widget” device into a single-serving container of beverage. The function of the widget is management of the characteristics of the beverage's “head”, which is the frothy foam on top of the beverage, produced by bubbles of gas rising to the surface when the beverage is poured. Examples of such widgets include “floating widgets” and widgets affixed to the bottom of the can. In nitrogen-infused beverages, the nitrogen may vaporize and expand in volume after a can is sealed, forcing gas and beverage into the widget's hollow interior through a hole in the widget. Other methods may be used to charge the widget with nitrogen during canning.

In addition, some nitrogen dissolves in the beverage. The presence of dissolved nitrogen allows smaller bubbles to be formed, which increases the creaminess of the head. This is because the smaller bubbles need a higher internal pressure to balance the greater surface tension, which is inversely proportional to the radius of the bubbles. When the can is opened, the pressure in the can quickly drops, causing the pressurized gas and beverage inside the widget to jet out from the hole. This agitation on the surrounding beverage causes a chain reaction of bubble formation throughout the beverage. The result, when the can is poured, is a surging mixture in the glass of very small gas bubbles and liquid.

However, cans using widgets have various drawbacks relative to widgetless cans. Cans with widgets are non-recyclable, more costly to produce, are not widely available in worldwide markets, require adjustments to manufacturing processes to produce, and are subject to additional challenge studies for product safety. Thus, it is desirable to package nitrogen-infused beverages in widgetless cans.

Various widgetless can packaging methods have been developed for nitrogen-infused beers. These methods generally work well for beer, as beer contains residual CO₂ generated from fermentation and contains a wide array of proteins derived from its grain bill, which provide a matrix for foam formation. However, to provide a high-quality nitro experience for non-alcoholic beverages, the methodology utilized for beer would not be sufficient. Non-alcoholic beverages, such as cold brew coffee, do not have residual CO₂. Thus, such processes would result in sub-standard quality of foam and “cascade”, a moving gradation of the foam from top-to-bottom, that consumers would expect from a nitrogen infused beverage.

Other processes for packaging non-alcoholic nitrogen infused beverages involve specialized, widgetless cans to inject nitrous oxide into the can through a valve at the bottom of the can to provide a frothy nitro beverage upon opening. However, such specialized cans again have several drawbacks relative to using a standard can. Furthermore, nitrous oxide is prohibited from being used in food and beverage products in certain markets and has negative consumer perception in other markets. Furthermore, the experience of such nitro beverages is inferior to the experience of a nitro beverage from a keg and tap system. For example, the cascade duration and generation are minimal in such beverages.

Many beverage companies also “infuse” nitrogen into their product through the addition of a liquid nitrogen dose. This process is insufficient to create the head and cascade experience expected of a nitrogen infused beverage.

As such, novel processes for producing and packaging non-alcoholic single-serve nitrogen infused beverages are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to methods of producing a non-alcoholic, nitrogen infused beverage, the method comprising: providing a non-alcoholic beverage; adding a foaming agent to the non-alcoholic beverage; dispensing the non-alcoholic beverage into a widgetless can; adding carbon dioxide (CO2) to the non-alcoholic beverage; and adding nitrogen (N2) to the non-alcoholic beverage after adding the carbon dioxide to the non-alcoholic beverage.

In some embodiments, the non-alcoholic beverage comprises coffee. In some embodiments, the non-alcoholic beverage comprises cold brew coffee. In some embodiments, the non-alcoholic beverage comprises tea. In some embodiments, the foaming agent comprises soapbark extract.

In some embodiments, the carbon dioxide is added to the non-alcoholic beverage by adding carbonated water to the non-alcoholic beverage. In some embodiments, the nitrogen added to the non-alcoholic beverage is in the form of liquid nitrogen.

In some embodiments, the method further comprises: sealing and inverting the can after adding the nitrogen to the non-alcoholic beverage; and retorting the can. In some embodiments, retorting the can comprises heating the can at about 121° C. for about 10 min.

In some embodiments, the method further comprises adding at least one of a sweetener, a flavor component, and a dairy component or alternative dairy component to the non-alcoholic beverage. In some embodiments, the sweetener comprises sugar. In some embodiments, the flavor component comprises vanilla, a mouthfeel enhancer, or a taste modulator. In some embodiments, the method further comprises: adding a dairy component or alternative dairy component to the non-alcoholic beverage; and adding a stabilizing agent to the non-alcoholic beverage, the stabilizing agent comprising pectin.

In some embodiments, the method further comprises adding a buffer to the non-alcoholic beverage. In some embodiments, about 30 g to about 35 g of liquid headspace is left in the widgetless can upon dispensing the non-alcoholic beverage into the widgetless can.

Some embodiments herein are directed to non-alcoholic, nitrogen infused beverages comprising: a non-alcoholic beverage; a foaming agent comprising soapbark extract; carbon dioxide (CO2); and nitrogen (N2), wherein the nitrogen is added to the non-alcoholic beverage in the form of liquid nitrogen.

In some embodiments, the beverage is stored in a widgetless can. In some embodiments, the non-alcoholic beverage comprises coffee. In some embodiments, the non-alcoholic beverage comprises cold brew coffee. In some embodiments, the non-alcoholic beverage comprises tea. In some embodiments, the beverage further comprises at least one of a sweetener, a flavor component, and a dairy component. In some embodiments, the sweetener comprises sugar. In some embodiments, the flavor component comprises vanilla, a mouthfeel enhancer, or a taste modulator.

In some embodiments, the ratio of N2:CO2 is between about 1:4 and about 4:1. In some embodiments, the ratio of N2:CO2 is about 1:1. In some embodiments, the beverage has a pH between about 6.5 and about 7.5. In some embodiments, the beverage has a pH between about 4.0 and about 4.2. In some embodiments, the beverage comprises a high acid beverage or acidified beverage. In some embodiments, the beverage further comprises a buffer. In some embodiments, when the beverage is dispensed from a widgetless can, produces a foam head that remains visible for 1 hour or more. In some embodiments, the beverage further comprises a stabilizing agent, the stabilizing agent comprising pectin. In some embodiments, the foaming agent is present in an amount of about 150 ppm.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates a flowchart of an example process for preparing a nitrogen infused beverage according to some embodiments herein.

FIG. 2 illustrates a nitrogen-infused beverage cascade effect over time according to some embodiments herein.

FIG. 3 illustrates a comparison of a nitrogen-infused beverage head over time according to some embodiments herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

The appeal of nitro cold brew coffee and other nitro drinks is three-fold as nitro drinks have a textural appeal, a taste appeal, and a visual appeal. Carbon dioxide (CO₂) is traditionally used to add carbonation to beverages. CO₂ creates a familiar fizzy texture and releases aromatics, allowing consumers to enjoy unique aromas in their beverages. CO₂ is highly soluble in beverages, meaning it dissolves well in water and diffuses out of solution relatively slowly. This creates large bubbles in a beverage that result in a fizzy texture and mouthfeel.

Nitrogen, on the other hand, is around 50× less soluble in water than CO₂. Thus, when nitrogen gas is infused into a beverage, it diffuses out of the solution quickly, forming smaller bubbles and a finer fizz that manifests as a smooth, slightly thick, and velvety texture with a foam head. The silky texture and foam head are a significant part of the popularity of nitro drinks with consumers, transforming a thin beverage that may be consumed quickly into a creamy drink that may be savored, examined, and enjoyed. In nitro cold brew products, the nitrogen infusion process produces a rich, silky texture and a thick and creamy foam head. Nitrogen permeates into the coffee structure, giving it a smooth and thick body.

Furthermore, unlike CO₂, nitrogen does not create any acidity, effectively removing that aspect from a beverage flavor profile, effectively sweetening the beverage. This also increases the drinkability of nitro beverages for those who might otherwise struggle with acid reflux or stomach issues. Additionally, nitrogen or nitrous oxide infusion of cold brew coffee may reveal additional flavor notes usually absent from cold brew.

Some embodiments herein may be directed to process for providing a globally compliant packaged nitrogen infused beverage with properties comparable to nitrogen beverages using keg and tap systems. As discussed above, currently, single-serve, packaged nitrogen infused beverages require the use of a specialized can, such as a widget can, or a combination of nitrogen sources including nitrous oxide. However, the embodiments herein can provide packaged, non-alcoholic nitro beverage products characterized by a distinct foam and cascade, without the use of a specialized widget can or the use of nitrous oxide.

Availability of widget cans is limited and establishing widget can manufacturing facilities is capital intensive for can manufacturers. Furthermore, widget cans are non-recyclable and require adjustments to traditional beverage canning lines that incur added capital expenses for manufacturers. The use of a widget can also necessitate additional microbial challenge studies to ensure food safety relative to traditional cans. Thus, it is desirable to use a traditional can to package nitrogen infused beverages.

Nitrous oxide (N₂O), while capable of producing a nitrogen infused beverage, is not permitted to be used as a food ingredient in some global markets. Also, nitrous oxide is considered a detrimental gas to the environment. It is therefore desirable to produce a nitrogen infused beverage using nitrogen (N₂) rather than nitrous oxide.

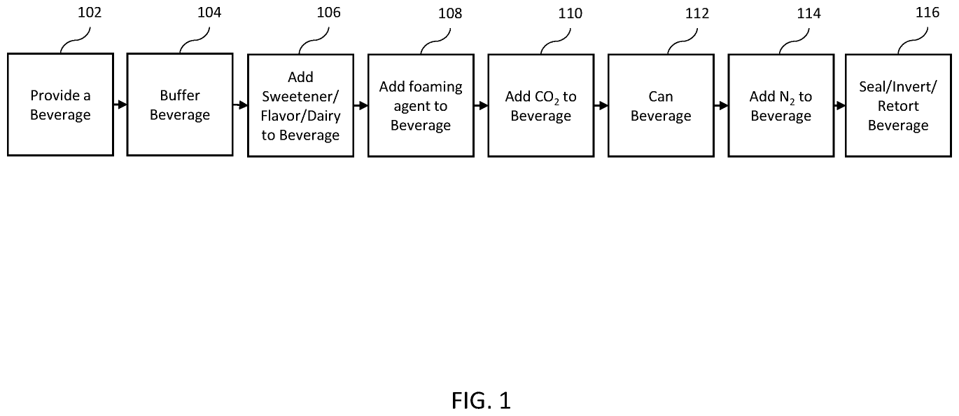

FIG. 1 illustrates a flowchart of an example process for preparing a nitrogen infused beverage according to some embodiments herein. In some embodiments, a nitrogen infused beverage may be prepared by providing a non-alcoholic beverage at 102. As used herein, the term “non-alcoholic beverage” has its ordinary and customary meaning, and includes, among other things, any edible non-alcoholic liquid or substantially liquid substance or product having a flowing quality (e.g., juices, coffee beverages, teas, frozen yogurt, cider, soft drinks, dairy drinks, flavored water, energy drinks, soups, broths, combinations of the same, or the like). In some embodiments, a coffee beverage or a cold brew coffee beverage may be used, which can be extracted using coffee beans.

It will be appreciated that a wide assortment of coffee beans may be employed within the scope of the present disclosure. For instance, in some embodiments the coffee beans may be roasted whole coffee beans, for example, yellow coffee beans, red coffee beans, partially roasted coffee beans, dark roast coffee beans, light roast coffee beans, non-decaffeinated coffee, partially decaffeinated coffee, fully decaffeinated coffee, or unroasted green coffee beans. The coffee used can be any variety or species from any part of the world, including blends thereof. For example, Arabica, Robusta, and any blend of Arabica & Robusta from any part of the world (such as Brazil, Indonesia, Central America, Africa, and the like). In some configurations, the coffee beans may comprise at least one of green coffee cherries, red coffee cherries, coffee flowers, coffee cherry skin, coffee cherry pulp, coffee cherry stalk, coffee cherry silverskin, coffee cherry mucilage, coffee cherry parchment, coffee cherry exocarp, coffee cherry mesocarp, and the like. Combinations of beans may be used in several embodiments.

In various configurations, the coffee beans are ground, or otherwise reduced to particles. In some embodiments, for some applications, a soluble cold brew powder instead of cold brew extract (i.e., instant coffee powder vs. brewed coffee) may be used. Soluble cold brew powders may be formed according to methods known to those skilled in the art. A variety of methods exist for reducing coffee beans to particles, and nearly any type of grinding equipment can be used within the context of the present disclosure to grind the beans. Non-limiting examples of grinding equipment include a cage mill, a hammer mill, a single-stage roller grinder, a multistage roller grinder, and the like. The beans may be reduced to an average particle size, as measured by mean particle diameter, ranging from about 90 μm to about 2,000 μm; including about 90 μm; about 100 μm; about 120 μm; about 140 μm; about 150 μm; about 170 μm; about 180 μm; about 200 μm; about 220 μm; about 250 μm; about 275 μm; about 300 μm; about 330 μm; about 360 μm; about 400 μm; about 450 μm; about 500 μm; about 750 μm; about 1,000 μm; about 1,200 μm; about 1,400 μm; about 1,500 μm; about 1750 μm; about 1900 μm; about 2000 μm; and any value therein. It will be appreciated that a smaller particle size increases the available surface area of the particulate, promoting efficient extraction. Thus, depending on the embodiment, the size of the coffee particle can be modified to aid in tailoring a flavor profile of the resulting beverage.

In various configurations, the coffee bean particles may be extracted to prepare a coffee beverage or cold brew coffee beverage. Any suitable solvent may be employed to extract the coffee bean particles. Typically, the extraction is performed using water, though any alternate solvent may be employed, such as ethanol, hexane, carbon dioxide, and the like. In some embodiments, the coffee bean particles are extracted with relatively cool water, such as about 0° C. to about 80° C., such as about 0° C.; about 10° C.; about 15 ° C.; about 2 ° C.; about 25° C.; about 30° C.; about 35° C.; about 40 ° C.; about 45° C.; about 50° C.; about 55° C., about 60° C.; about 70° C.; about 80° C.; and any value therein. A cold brew coffee beverage may be prepared by extracting the coffee beans in cold water, such as water at less than about 30 ° C., less than about 20 ° C., or less than about 10 ° C. For example, when the provided non-alcoholic beverage is cold brew coffee, the coffee bean particles may not be subjected to water extraction at a temperature greater than 30° C. and may be extracted for 12 hours or more. In some embodiments, the coffee bean particles may be extracted in water at a temperature of about 18° C. to about 22° C. for a period of about 20 hours. In some embodiments, cold brew coffee beverages may be preferred as cold brew coffee generally comprises a creamy, smooth brew, with less bitterness and sour notes compared to other coffee beverages. These properties are synergetic with nitrogen infusion, which creates the cascade of nitrogen gas bubbles floating up through the coffee, provides a unique flavor and freshness, and adds a thickness to the body of the coffee. Without being limited by any particular theory, cold brewing extracts fewer tannins from the coffee beans and reduces the acidity of the nitrogen infused beverage. As such, cold brew coffee brings out a subtle, more intricate flavor which the nitrogen protects to provide a fresh flavor. In addition, in some embodiments, the lack of acidity and the natural creaminess of a nitro brew beverage allows for some consumers to enjoy the beverage optionally without additional flavor components, sweeteners, or dairy components. In some embodiments, the beverage may comprise water mixed with soluble coffee and one or more flavoring components.

In some embodiments, the non-alcoholic beverage may comprise tea. In some embodiments, the tea may comprise any beverage extracted or otherwise processed from the plant Camellia sinensis. In some embodiments, the tea may comprise black tea, green tea, white tea, oolong tea, pu-erh tea, purple tea, matcha tea. In some embodiments, the tea may comprise a flavored tea, which may be prepared by combining the tea with one or more spices, herbs, fruits, sweeteners, additives, and/or flowers. In some embodiments, the tea may also comprise beverages not prepared using the Camellia sinensis plant, such as mate tea, rooibos tea, or herbal tea (i.e., herbal infusions or tisanes), such as peppermint tea or chamomile tea. In some embodiments, the tea may comprise a beverage prepared using a blend of any one or more tea solids. In some embodiments, when the non-alcoholic beverage comprises tea, the beverage may comprise about 0.2% to about 0.8% tea solids on a dry basis.

In some embodiments, the non-alcoholic beverage may be optionally buffered at 104. For example, natural coffee contains various organic acids (e.g., non-volatile acids such as caffeic, chlorogenic, citric, malic, oxalic, quinic, and tartaric), which may make the beverage quite acidic. Additionally, when coffee is contacted with CO₂, carbonic acid may be formed. In some embodiments, a buffer is used stabilize the pH of the liquid. As noted above, coffee is mildly acidic, and the buffer may neutralize the acidic compounds by transforming the compounds into conjugate partners. In some embodiments, the buffer may balance the flavor of the coffee, which may be too acidic upon addition of CO₂. The buffer used in the beverages and methods described herein is not particularly limited and may include, for example, carbonate or bicarbonate. In some embodiments, buffer may be included in the amount of about 0.05% to about 0.2% by weight.

In some embodiments, the buffer may be added to increase the pH of the beverage to about 6.5 to about 7.5. In some embodiments, the buffer may be added to increase the pH of the beverage to about 6.5, about 6.6, about 6.7, about 6.8, about 6.9, about 7.0, about 7.1, about 7.2, about 7.3, about 7.4, about 7.5, or any value between the aforementioned value. In some embodiments, a buffer may not be added to the non-alcoholic beverage. Without the use of a buffer, the non-alcoholic beverage may have a pH between about 4.0 and about 4.2.

In some embodiments, a sweetener, flavor component, and/or dairy component may be added to the non-alcoholic beverage at 106, either before or after buffering the coffee. The sweetener used in the methods described herein is not particularly limited and may include, for example, cane sugar, fructose, corn syrup, crystalline fructose, dextrose, malto-dextrose, maltodextrin, glycerine, threitol, erythritol, rebaudioside A, stevia, xylitol, arabitol, ribitol, sorbitol, mannitol, maltitol, maltotriitol, maltotetraitol, lactitol, hydrogenated isomaltulose, hydrogented starch, shellac, ethyl cellulose, hydroxy propyl methylcellulose, starches, modified starches, carboxyl cellulose, carrageenan, cellulose acetate phthalate, cellulose acetate trimellitate, chitosan, corn syrup solids, dextrins, fatty alcohols, hydroxy cellulose, hydroxy ethyl cellulose, hydroxy methyl cellulose, hydroxy propyl cellulose, hydroxy propyl ethyl cellulose, hydroxy propyl methyl cellulose, hydroxy propyl methyl cellulose phthalate, polyethylene glycol or a combination thereof. In addition, the sweetener may have various levels of granularity. For example, granulated sugar, baker's sugar, sanding sugar, etc. may be used. In some embodiments a more highly granulated sweetener may be used.

In some embodiments, the amount of sweetener added may be about 0% to about 10% by weight. In some embodiments, the amount of sweetener added may be about 0% by weight, about 1% by weight, about 2% by weight, about 3% by weight, about 4% by weight, about 5% by weight, about 6% by weight, about 7% by weight, about 8% by weight, about 9% by weight, about 10% by weight, or any value between the aforementioned values. In some embodiments, the sweetener may be about 2% by weight. In some embodiments, the sweetener may be used to offset the flavor provided by CO₂.

Furthermore, it may be desirable to add additional flavor components to the beverage. It will be appreciated that a wide assortment of additional flavorings may be added to a nitrogen-infused beverage, either before or after the infusion. Non-limiting examples of flavoring include vanilla, chocolate, hazelnut, caramel, cinnamon, mint, eggnog, apple, apricot, aromatic bitters, banana, berry, blackberry, blueberry, celery, cherry, cranberry, strawberry, raspberry, juniper berry, brandy, cachaca, carrot, citrus, lemon, lime, orange, grapefruit, tangerine, coconut, cola, menthol, gin, ginger, licorice, hot, milk, nut, almond, macadamia nut, peanut, pecan, pistachio, walnut, peach, pear, pepper, pineapple, plum, quinine, rum, white rum, dark rum, sangria, shellfish, clam, tea, black tea, green tea, tequila, tomato, top note, tropical, vermouth, dry vermouth, sweet vermouth, whiskey, bourbon whiskey, Irish whiskey, rye whiskey, Scotch whisky, Canadian whiskey, red pepper, black pepper, horseradish, wasabi, jalapeno pepper, chipotle pepper essential oils, concretes, absolutes, resins, resinoids, balms, tinctures, soybean oil, coconut oil, palm oil, kern oil, sunflower oil, peanut oil, almond oil, cocoa butter, amyris oil, angelica seed oil, angelica root oil, aniseed oil, valerian oil, basil oil, tarragon oil, eucalyptus citriodora oil, eucalyptus oil, fennel oil, fir needle oil, galbanum oil, galbanum resin, geranium oil, grapefruit oil, guaiac wood oil, guaiac balsam, guaiac balsam oil, helichrysum absolute, helichrysum oil, ginger oil, iris root absolute, iris root oil, jasmin absolute, calmus oil, chamomile oil bleu, chamomile oil roman, carrot seed oil, cascarilla oil, mint oil, carvi oil, labdanum oil, labdanum absolute, labdanum resin, lavandin absolute, lavandin oil, lavender absolute, lavender oil, lemongrass oil, Bursera penicillata (linaloe) oil, litsea-cubeba oil, bay laurel leaf oil, macis oil, marjoram oil, mandarin oil, massoirinde oil, mimosa absolute, ambrette seed oil, ambrette tincture, muskatelle salbei oil, nutmeg oil, orange blossom absolute, orange oil, oregano oil, palmarosa oil, patchouli oil, perilla oil, parsley leaf oil, parsley seed oil, clove seed oil, peppermint oil, pepper oil, pimento oil, pine oil, poley oil, rose absolute, rose wood oil, rose oil, rosemary oil, sage oil, lavandin, sage oil Spanish, sandalwood oil, celery seed oil, lavender spike oil, star anis oil, styrax oil, tagetes oil, pine needle oil, tea-tree oil, turpentine oil, thyme oil, tolu balm, tonka absolute, tuberose absolute, vanilla extract, violet leaf absolute, verbena oil, vetiver oil, juniper berry oil, wine yeast oil, wormwood oil, wintergreen oil, ylang oil, hyssop oil, civet absolute, cinnamon leaf oil, cinnamon bark oil etc. any other type of food flavoring or edible substance or a combination thereof.

In some embodiments, the amount of flavor component added may be about 0% to about 10% by weight. In some embodiments, the amount of flavor component added may be about 0% by weight, about 0.1% by weight, about 0.2% by weight, about 0.3% by weight, about 0.4% by weight, about 0.5% by weight, about 0.6% by weight, about 0.7% by weight, about 0.8% by weight, about 0.9% by weight, about 1% by weight, about 2% by weight, about 3% by weight, about 4% by weight, about 5% by weight, about 6% by weight, about 7% by weight, about 8% by weight, about 9% by weight, about 10% by weight, or any value between the aforementioned values. In some embodiments, the flavor component may be about 0.1% by weight. In some embodiments, the sweetener may be used to offset the flavor provided by CO₂.

In some embodiments, it may be desirable to add one or more dairy components and/or alternative dairy components to the beverage. In some embodiments, dairy components and/or alternative dairy components may comprise one or more of cow milk (including whole milk, 2% milk, 1% milk, low-fat milk, fat-free (i.e., skim or skimmed) milk, organic milk, lactose-free milk, and raw milk), goat milk, buttermilk, condensed milk, cashew milk, oat milk, almond milk, toned milk, buffalo milk, rice milk, hemp milk, coconut milk, cashew milk, soy milk, full cream milk, evaporated milk, flavored milk, pea milk, sheep milk, camel milk, potato milk, quinoa milk, or any other plant-based or animal-based milk or dairy product.

In some embodiments, the addition of one or more dairy components and/or alternative dairy components to a nitro beverage may introduce additional complications in processing the beverage. For example, introducing dairy into a mixed gas system comprising both nitrogen and CO₂ may form unwanted products in the beverage, including, for example, carbonic acid. Additionally, addition of dairy to the beverage may result in protein denaturation of the dairy or alternative dairy component and/or general instability of the beverage. In some embodiments, to avoid these complications, a stabilizing agent, such as pectin, may be added with the one or more dairy components and/or alternative dairy components to stabilize the beverage. In some embodiments, the stabilizing agent may be added in an amount of about 0.05% to about 0.5% by weight of the beverage. In some embodiments, the stabilizing agent may be added in an amount of about 0.05%, about 0.06%, about 0.07%, about 0.08%, about 0.09%, about 0.1%, about 0.11%, about 0.12%, about 0.13%, about 0.14%, about 0.15%, about 0.16%, about 0.17%, about 0.18%, about 0.19%, about 0.2%, about 0.21%,a bout 0.22%, about 0.23%, about 0.24%, about 0.25%, about 0.26%,about 0.27%, about 0.28%, about 0.29%, about 0.3%, about 0.31%, about 0.32%, about 0.33%,about 0.34%, about 0.35%, about 0.36%, about 0.37%, about 0.38%, about 0.39%, about 0.4%,about 0.41%, about 0.42%, about 0.43%, about 0.44%, about 0.45%, about 0.46%, about 0.47%, about 0.48%, about 0.49%, about 0.5%, or between any of the aforementioned values. In some embodiments, the amount of pectin added may increase with the amount of the one or more dairy components and/or alternative dairy components added to the beverage. In some embodiments, alternative dairy nitro infused beverages may be prepared with a lower amount or no stabilizing agent added. In some embodiments, the one or more dairy components and/or alternative dairy components are added to the solution with water and/or the stabilizing agent after buffering. In some embodiments, the solution with dairy may be maintained at boiling temperature for a predetermined amount of time, such as about 30 min. In some embodiments, after boiling the solution, the solution may be cooled to about 100° F. and shear mixed with the one or more dairy components dairy for about 10 min.

In some embodiments, the stabilizing agent may comprise pectin. In some embodiments, the stabilizing agent may comprise a stabilizer, a thickening agent, or a gelling agent. In some embodiments, the stabilizing agent may comprise a hydrocolloid (such as xanthan, gum arabic and gum acacia), modified starch, a carrageenan, casein, or inulin.

In some embodiments, the addition of one or more dairy components and/or alternative dairy components enables production of nitro infused dairy beverages, such as nitro latte, nitro cappuccino, nitro macchiato, nitro flat white, nitro mocha, nitro cortado, nitro breve, nitro vienna, nitro affogato, nitro milk tea, and nitro bubble tea, among others.

In some embodiments, the one or more dairy components and/or alternative dairy components may be added in an amount of about 10% to about 15% by weight of the beverage. In some embodiments, the one or more dairy components and/or alternative dairy components may be added in an amount of about 0%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or any value between the aforementioned values.

In some embodiments, a foaming agent is added to the non-alcoholic beverage at 108. In some embodiments, a foaming agent is necessary to produce a foam head of sufficient size and duration, comparable to a beverage made using a keg and tap system. A foaming agent is a material that facilitates the formation of foam, such as a surfactant or a blowing agent. A surfactant, when present in small amounts, reduces surface tension of the beverage, or increases its colloidal stability by inhibiting coalescence of bubbles. A blowing agent is a gas that forms the gaseous part of the foam. In some embodiments, the foaming agent comprises a surfactant or a blowing agent. In some embodiments, coffee beverages do not contain a substantial amount of protein and require the addition of a foaming agent to achieve the organoleptic characteristics of a widget can nitro experience.

Preferably, the foaming agent comprises soapbark extract (Quillaja Saponaria Extract). In some embodiments, the foaming agent comprises a plant-based, edible extract. In some embodiments, the foaming agent comprises gelatin, lecithin, agar, sucrose surfactant, or a hydrophobin, inulin, chickaree extract, or propylene glycol alginate (PGA). In some embodiments, the foaming agent may be added in an amount of about 150 ppm. In some embodiments, the foaming agent may be added in an amount of about 75 ppm to about 1500 ppm. In some embodiments, the foaming agent may be added in an amount of about 75 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, about 700 ppm, about 725 ppm, about 750 ppm, about 775 ppm, about 800 ppm, about 825 ppm, about 850 ppm, about 875 ppm, about 900 ppm, about 925 ppm, about 950 ppm, about 975 ppm, about 1000 ppm, about 1025 ppm, about 1050 ppm, about 1075 ppm, about 1100 ppm, about 1125 ppm, about 1150 ppm, about 1175 ppm, about 1200 ppm, about 1225 ppm, about 1250 ppm, about 1275 ppm, about 1300 ppm, about 1325 ppm, about 1350 ppm, about 1375 ppm, about 1400 ppm, about 1425 ppm, about 1450 ppm, about 1475 ppm, about 1500 ppm, or any values between the aforementioned values.

In some embodiments, carbon dioxide (CO₂) may be added to the non-alcoholic beverage. In some embodiments, CO₂ may be added in the form of carbonated water. In other embodiments, gaseous CO₂ may be infused into the beverage. In some embodiments, the addition of CO₂ is necessary as it facilitates nitrogen diffusion through the beverage and, along with the nitrogen and foaming agent, produces an ideal foam head height and duration, cascade duration and generation, and bubble size when the beverage is opened and poured. In some embodiments, addition of CO₂ may allow for greater nitrogen retention within the canned beverage. In some embodiments, CO₂ is necessary to aid with the duration of the cascading, and generation and retention of foam, thereby increasing the visual and mouthfeel experience relative to using nitrogen alone. According to the embodiments herein, a nitrogen infused beverage may be prepared having a foam height of about 5 mm to about 20 mm. For example, in some embodiments, a nitrogen infused beverage may be prepared having a foam height of about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, or any value between the aforementioned values.

According to the embodiments herein, a nitrogen infused beverage may be prepared having a foam duration of about 1 min to about 60 min, measured from the time of pouring the beverage from the can until the foam head is no longer visible. For example, in some embodiments, a nitrogen infused beverage may be prepared having a foam duration of about 1 min, about 2 min, about 3 min, about 4 min, about 5 min, about 10 min, about 15 min, about 20 min, about 25 min, about 30 min, about 35 min, about 40 min, about 45 min, about 50 min, about 55 min, about 60 min, or any value between the aforementioned values. According to the embodiments herein, a nitrogen infused beverage may be prepared having a cascade duration of about 15 sec to about 60 sec. For example, in some embodiments, a nitrogen infused beverage may be prepared having a cascade duration of about 15 sec, about 20 sec, about 25 sec, about 30 sec, about 35 sec, about 40 sec, about 45 sec, about 50 sec, about 55 sec, about 60 sec, or any value between the aforementioned values.

In some embodiments, carbonated water may be added to the non-alcoholic beverage in an amount of about 3 g/L or about 4 g/L. In some embodiments, carbonated water may be added to the non-alcoholic beverage in an amount between about 1 g/L and about 10 g/L. In some embodiments, carbonated water may be added to the non-alcoholic beverage in an amount of about 1 g/L, about 2 g/L, about 3 g/L, about 4 g/L, about 5 g/L, about 6 g/L, about 7 g/L, about 8 g/L, about 9 g/L, about 10 g/L, or any value between the aforementioned values. In some embodiments, the beverage may comprise about 1 g/L to about 2.5 g/L dissolved CO₂.

Before or after CO₂ is added to the non-alcoholic beverage, the beverage may be placed into an unsealed can at 112. In some embodiments, the can is filled to a volume of about 80% to about 85%, leaving between about 15% and about 20% headspace in the can. In some embodiments, about 30 g to about 35 g of liquid headspace can be left in the can prior to dosing liquid nitrogen. In some embodiments, the headspace allows the expansion of the dissolved gases during pasteurization/sterilization and keep the packaging of the beverage intact.

In some embodiments, after CO₂ is added to the non-alcoholic beverage, liquid nitrogen (N₂) may be dosed into the beverage at 114. In some embodiments, N₂ may be added with a ratio of N₂:CO₂ of about 1:4 to about 4:1. For example, in some embodiments, N₂ may be added with a ratio of N₂:CO₂ of 1:1. In some embodiments, N₂ may be added with a ratio of N₂:CO₂ of about 1:4, about 1:3, about 1:2, about 1:1, about 2:1, about 3:1, about 4:1, or any ratio between the aforementioned ratios. Preferably, N₂ may be added with a ratio of N₂:CO₂ of about 1:2 to about 1:3. In some embodiments, it is necessary to add N₂ after CO₂ is added in order to achieve the necessary nitrogen retention in the beverage to create a nitrogen infused beverage with sufficient head and cascade characteristics. In some embodiments, the liquid nitrogen may be dosed for about 70 msec in an amount of about 0.8 g of nitrogen.

In some embodiments, liquid nitrogen may be added to the non-alcoholic beverage in an amount of about 3 g/L or about 4 g/L. In some embodiments, liquid nitrogen may be added to the non-alcoholic beverage in an amount between about 1 g/L and about 10 g/L. In some embodiments, liquid nitrogen may be added to the non-alcoholic beverage in an amount of about 1 g/L, about 2 g/L, about 3 g/L, about 4 g/L, about 5 g/L, about 6 g/L, about 7 g/L, about 8 g/L, about 9 g/L, about 10 g/L, or any value between the aforementioned values.

In some embodiments, after dosing the beverage with liquid nitrogen, the can may be sealed (e.g., seamed) and inverted at 116. The product may also be retorted without need for overpressure at 116. In some embodiments, retorting may comprise heating the cans at about 121° C. for between 5 min and 20 min, based on the recipe, pH, Brix and local regulations. During retort, the gas within the can may expand, filling the extra headspace left in the can. In some embodiments, if a buffer is not used, a high-acid beverage may not require retorting. In some embodiments, additional thermal high-pressure processing (HPP) may be used as known to those skilled in the art.

In some embodiments, the process therefore comprises producing a mixed gas beverage supported with a foaming agent. Liquid nitrogen and carbon dioxide are added to the beverage, with the addition of a foaming agent, such as soapbark extract. In some embodiments, this process provides a nitrogen infused beverage with foaming and cascading capabilities that are equivalent to a nitro experience delivered through a widget can, without the need for the widget or the use of nitrous oxide. In some embodiments, the can may need to be shaken or agitated to produce ideal foaming and cascading effects.

The beverages described herein provide a nitro experience at least equivalent to a beverage poured using a nitro draught or a widget can, and an improved nitro experience in comparison to nitrous oxide or nitrogen alone. The process according to some embodiments herein is also more sustainable (e.g., fully recyclable) than widget cans. Furthermore, the process described herein does not require special adjustments to a manufacturing line and can be applied to any package, reducing costs associated with specialized packaging (e.g., widget cans). The process may be used in markets globally, even those in which nitrous oxide is prohibited for use in beverage. The nitrogen beverages described herein do not present any additional food safety risks and is environmentally friendly.

When fully nitrogenated and cooled properly, a nitrogen infused beverage according to the embodiments herein, when poured from a traditional can, comprises micro-fine nitrogen bubbles rising gently from the beverage, displacing the beverage and forcing it to settle downwards causing a visual cascading or falling impression for a sufficient period of time. The nitrogen bubbles then accumulate on top of the beverage, creating a head of sufficient size and duration. In some embodiments, the head duration may be about 1 hour. In some embodiments, the head duration may be between about 5 min and 2 hours. In some embodiments, pouring the nitrogen infused beverage results in a cascade running the length of the beverages total occupied volume. For example, if 100 ml of the nitrogen infused product is poured into a 100 ml volumetric cylinder, the cascade may begin at the bottom of the cylinder and rise continuously to the top (100 ml mark) of the cylinder.

In some embodiments, the accumulation of the nitrogen bubbles adheres to the natural sugars and oils contained in coffee creating a creamy and sweet taste in the beverage. In some embodiments, the beverage has a smooth, somewhat viscous mouthfeel that can be enjoyed without adding cream, sugar, other flavours, and sweeteners.

Nitrogen infused beverages which according to the embodiments described herein can remain stable and provide the above properties when poured for at least about six months to at least about one year provided that there is no microbial activity present. In some embodiments, nitrogen helps to eliminate carbon dioxide and oxygen which contributes to the stability of the brew.

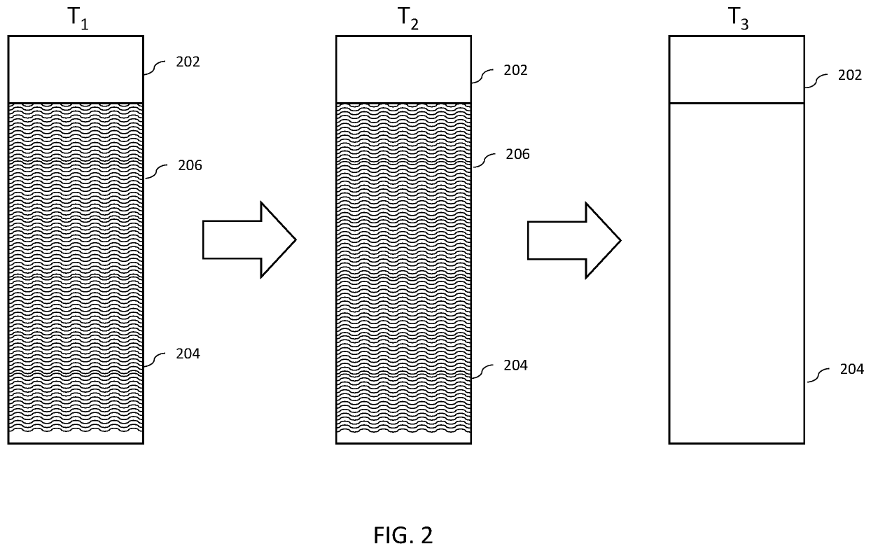

FIG. 2 illustrates a nitrogen-infused beverage prepared according to the embodiments herein. In some embodiments, the methods herein produce a beverage having a rich, silky texture and a thick and creamy foam head. In some embodiments, the foam head may comprise a height of over 2 cm about 17 sec after dispensing the nitrogen infused beverage. The methods described herein may produce a nitrogen-infused beverage with a foam head of sufficient size and duration, comparable to a beverage made using a keg and tap system. In some embodiments, the foam head may sustain a height of over 1 cm at around 73 sec after dispensing the beverage.

Additionally, in some embodiments, the beverage may exhibit a visible cascade of nitrogen gas bubbles floating up through the coffee. This effect is achieved without the use of a widget can and may remain visible for at least about 60 sec after dispensing the beverage. In some embodiments, at time T₁, a nitrogen infused beverage 204 may be poured directly from a standard can into a beverage container 202, such as, for example, a glass, mug, or cup. At time T₁, the nitrogen infused beverage 204 may exhibit a visible cascade 206 at T₁. In some embodiments, at time T₂, which may be an amount of time after T₁, the cascade 206 may remain visible. In some embodiments, a visible cascade may remain visible for about 90 sec to about 120 sec for nitro beverages comprising tea, and for about 60 sec for nitro beverages comprising coffee

In some embodiments, time T₂ may be at least about 60 sec after time T₁. In some embodiments, time T₂ may be at least about 0 sec, about 5 sec, about 10 sec, about 15 sec, about 20 sec, about 25 sec, about 30 sec, about 35 sec, about 40 sec, about 45 sec, about 50 sec, about 55 sec, about 60 sec, about 65 sec, about 70 sec, about 75 sec, about 80 sec, about 85 sec, about 90 sec, about 95 sec, about 100 sec, about 105 sec, about 110 sec, about 115 sec, about 120 sec, about 125 sec, about 130 sec, about 135 sec, about 140 sec, about 145 sec, about 150 sec, about 155 sec, about 160 sec, about 165 sec, about 170 sec, about 175 sec, about 180 sec, about 185 sec, about 190 sec, about 195 sec, about 200 sec, about 205 sec, about 210 sec, about 215 sec, about 220 sec, about 225 sec, about 230 sec, about 235 sec, about 240 sec, about 245 sec, about 250 sec, about 255 sec, about 260 sec, about 265 sec, about 270 sec, about 275 sec, about 280 sec, about 285 sec, about 290 sec, about 295 sec, about 300 sec, about 305 sec, about 310 sec, about 315 sec, about 320 sec, about 325 sec, about 330 sec, about 335 sec, about 340 sec, about 345 sec, about 350 sec, about 355 sec, about 360 sec, about 365 sec, about 370 sec, about 375 sec, about 380 sec, about 385 sec, about 390 sec, about 395 sec, about 400 sec, about 405 sec, about 410 sec, about 415 sec, about 420 sec, about 425 sec, about 430 sec, about 435 sec, about 440 sec, about 445 sec, about 450 sec, about 455 sec, about 460 sec, about 465 sec, about 470 sec, about 475 sec, about 480 sec, about 485 sec, about 490 sec, about 495 sec, about 500 sec, about 505 sec, about 510 sec, about 515 sec, about 520 sec, about 525 sec, about 530 sec, about 535 sec, about 540 sec, about 545 sec, about 550 sec, about 555 sec, about 560 sec, about 565 sec, about 570 sec, about 575 sec, about 580 sec, about 585 sec, about 590 sec, about 595 sec, or about 600 sec after T₁(i.e., the time that the nitrogen infused beverage 204 is poured), or any value between the aforementioned values. In some embodiments, at time T₃, which may be an amount of time after T₂, the cascade 206 may disappear.

In some embodiments, time T₃ may be at least about 0 sec, about 5 sec, about 10 sec, about 15 sec, about 20 sec, about 25 sec, about 30 sec, about 35 sec, about 40 sec, about 45 sec, about 50 sec, about 55 sec, about 60 sec, about 65 sec, about 70 sec, about 75 sec, about 80 sec, about 85 sec, about 90 sec, about 95 sec, about 100 sec, about 105 sec, about 110 sec, about 115 sec, about 120 sec, about 125 sec, about 130 sec, about 135 sec, about 140 sec, about 145 sec, about 150 sec, about 155 sec, about 160 sec, about 165 sec, about 170 sec, about 175 sec, about 180 sec, about 185 sec, about 190 sec, about 195 sec, about 200 sec, about 205 sec, about 210 sec, about 215 sec, about 220 sec, about 225 sec, about 230 sec, about 235 sec, about 240 sec, about 245 sec, about 250 sec, about 255 sec, about 260 sec, about 265 sec, about 270 sec, about 275 sec, about 280 sec, about 285 sec, about 290 sec, about 295 sec, about 300 sec, about 305 sec, about 310 sec, about 315 sec, about 320 sec, about 325 sec, about 330 sec, about 335 sec, about 340 sec, about 345 sec, about 350 sec, about 355 sec, about 360 sec, about 365 sec, about 370 sec, about 375 sec, about 380 sec, about 385 sec, about 390 sec, about 395 sec, about 400 sec, about 405 sec, about 410 sec, about 415 sec, about 420 sec, about 425 sec, about 430 sec, about 435 sec, about 440 sec, about 445 sec, about 450 sec, about 455 sec, about 460 sec, about 465 sec, about 470 sec, about 475 sec, about 480 sec, about 485 sec, about 490 sec, about 495 sec, about 500 sec, about 505 sec, about 510 sec, about 515 sec, about 520 sec, about 525 sec, about 530 sec, about 535 sec, about 540 sec, about 545 sec, about 550 sec, about 555 sec, about 560 sec, about 565 sec, about 570 sec, about 575 sec, about 580 sec, about 585 sec, about 590 sec, about 595 sec, or about 600 sec after T₂, or any value between the aforementioned values.

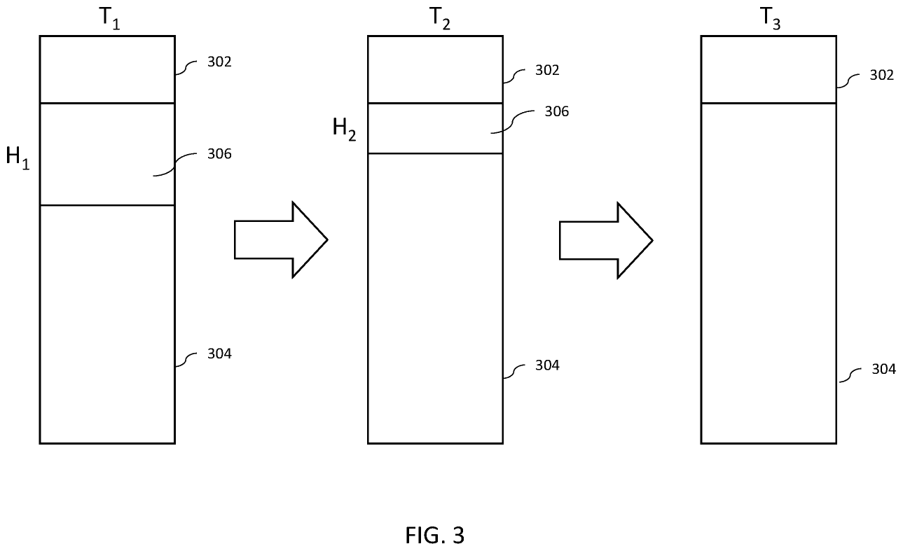

FIG. 3 illustrates a comparison of a nitrogen-infused beverage head over time according to some embodiments herein. In some embodiments, a nitrogen-infused beverage prepared according to the methods herein may exhibit similar foam head height and duration, as well as a visible cascade effect comparable to a beverage dispensed from a widget can. In fact, a nitrogen-infused beverage prepared according to the methods herein may have a larger foam head than a beverage dispensed from a widget can, with the foam head remaining larger for at least 60 min from dispensing the beverages. In addition, the nitrogen-infused beverage prepared according to the methods herein may produce a visible cascading effect comparable to that produced in a beverage dispensed from a widget can. In some embodiments, at time T₁, a nitrogen infused beverage 304 may be poured directly from a standard can into a beverage container 302, such as, for example, a glass, mug, or cup. At time T₁, the nitrogen infused beverage 304 may exhibit a foam head 306 having a height H₁ at T₁₆. In some embodiments, at time T₂, which may be an amount of time after T₁, the foam head 306 may remain visible, and may have a height H₂. In some embodiments, the height H₂ at time T₂ may be the same as H₁ or may be smaller than H₁, as the foam head disappears over time. In some embodiments, at time T₃, which may be an amount of time after T₂, the foam head 306 may disappear.

In some embodiments, time T₂ may be at least about 60 sec after time T₁. In some embodiments, time T₂ may be at least about 0 sec, about 5 sec, about 10 sec, about 15 sec, about 20 sec, about 25 sec, about 30 sec, about 35 sec, about 40 sec, about 45 sec, about 50 sec, about 55 sec, about 60 sec, about 65 sec, about 70 sec, about 75 sec, about 80 sec, about 85 sec, about 90 sec, about 95 sec, about 100 sec, about 105 sec, about 110 sec, about 115 sec, about 120 sec, about 125 sec, about 130 sec, about 135 sec, about 140 sec, about 145 sec, about 150 sec, about 155 sec, about 160 sec, about 165 sec, about 170 sec, about 175 sec, about 180 sec, about 185 sec, about 190 sec, about 195 sec, about 200 sec, about 205 sec, about 210 sec, about 215 sec, about 220 sec, about 225 sec, about 230 sec, about 235 sec, about 240 sec, about 245 sec, about 250 sec, about 255 sec, about 260 sec, about 265 sec, about 270 sec, about 275 sec, about 280 sec, about 285 sec, about 290 sec, about 295 sec, about 300 sec, about 305 sec, about 310 sec, about 315 sec, about 320 sec, about 325 sec, about 330 sec, about 335 sec, about 340 sec, about 345 sec, about 350 sec, about 355 sec, about 360 sec, about 365 sec, about 370 sec, about 375 sec, about 380 sec, about 385 sec, about 390 sec, about 395 sec, about 400 sec, about 405 sec, about 410 sec, about 415 sec, about 420 sec, about 425 sec, about 430 sec, about 435 sec, about 440 sec, about 445 sec, about 450 sec, about 455 sec, about 460 sec, about 465 sec, about 470 sec, about 475 sec, about 480 sec, about 485 sec, about 490 sec, about 495 sec, about 500 sec, about 505 sec, about 510 sec, about 515 sec, about 520 sec, about 525 sec, about 530 sec, about 535 sec, about 540 sec, about 545 sec, about 550 sec, about 555 sec, about 560 sec, about 565 sec, about 570 sec, about 575 sec, about 580 sec, about 585 sec, about 590 sec, about 595 sec, or about 600 sec after T₁ (i.e., the time that the nitrogen infused beverage 204 is poured), or any value between the aforementioned values.

In some embodiments, time T₃ may be at least about 0 sec, about 5 sec, about 10 sec, about 15 sec, about 20 sec, about 25 sec, about 30 sec, about 35 sec, about 40 sec, about 45 sec, about 50 sec, about 55 sec, about 60 sec, about 65 sec, about 70 sec, about 75 sec, about 80 sec, about 85 sec, about 90 sec, about 95 sec, about 100 sec, about 105 sec, about 110 sec, about 115 sec, about 120 sec, about 125 sec, about 130 sec, about 135 sec, about 140 sec, about 145 sec, about 150 sec, about 155 sec, about 160 sec, about 165 sec, about 170 sec, about 175 sec, about 180 sec, about 185 sec, about 190 sec, about 195 sec, about 200 sec, about 205 sec, about 210 sec, about 215 sec, about 220 sec, about 225 sec, about 230 sec, about 235 sec, about 240 sec, about 245 sec, about 250 sec, about 255 sec, about 260 sec, about 265 sec, about 270 sec, about 275 sec, about 280 sec, about 285 sec, about 290 sec, about 295 sec, about 300 sec, about 305 sec, about 310 sec, about 315 sec, about 320 sec, about 325 sec, about 330 sec, about 335 sec, about 340 sec, about 345 sec, about 350 sec, about 355 sec, about 360 sec, about 365 sec, about 370 sec, about 375 sec, about 380 sec, about 385 sec, about 390 sec, about 395 sec, about 400 sec, about 405 sec, about 410 sec, about 415 sec, about 420 sec, about 425 sec, about 430 sec, about 435 sec, about 440 sec, about 445 sec, about 450 sec, about 455 sec, about 460 sec, about 465 sec, about 470 sec, about 475 sec, about 480 sec, about 485 sec, about 490 sec, about 495 sec, about 500 sec, about 505 sec, about 510 sec, about 515 sec, about 520 sec, about 525 sec, about 530 sec, about 535 sec, about 540 sec, about 545 sec, about 550 sec, about 555 sec, about 560 sec, about 565 sec, about 570 sec, about 575 sec, about 580 sec, about 585 sec, about 590 sec, about 595 sec, or about 600 sec after T₂, or any value between the aforementioned values.

As noted above, availability of widget cans is limited and establishing widget can manufacturing facilities is capital intensive for can manufacturers. Furthermore, widget cans are non-recyclable and require adjustments to traditional beverage canning lines that incur added capital expenses for manufacturers. The use of a widget can also necessitate additional microbial challenge studies to ensure food safety relative to traditional cans. Thus, it is very desirable to produce a nitrogen-infused beverage exhibiting similar visual, textural, and flavor effects to a nitrogen-infused beverage from a widget can using a standard can.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein. Overall, the language of the claims is to be interpreted broadly based on the language employed in the claims. The claims are not to be limited to the non-exclusive embodiments and examples that are illustrated and described in this disclosure, or that are discussed during the prosecution of the application.

Those skilled in the art will also appreciate that in some embodiments the functionality provided by the components, structures, methods and processes discussed above may be provided in alternative ways, such as being split among more components or methods or consolidated into fewer components or methods. In addition, while various methods may be illustrated as being performed in a particular order, those skilled in the art will appreciate that in other embodiments the methods may be performed in other orders and in other manners.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage preparation systems, techniques and methods have been disclosed. Although the systems, techniques, and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above but should be determined only by a fair reading of the claims that follow as well as their full scope of equivalents.

What is claimed is:

1. A method of producing a non-alcoholic, nitrogen infused beverage, the method comprising:
providing a non-alcoholic beverage;
adding a foaming agent to the non-alcoholic beverage;
dispensing the non-alcoholic beverage into a widgetless can;
adding carbon dioxide (CO₂) to the non-alcoholic beverage; and
adding nitrogen (N₂) to the non-alcoholic beverage after adding the carbon dioxide to the non-alcoholic beverage.

2. The method of claim 1, wherein the non-alcoholic beverage comprises coffee.

3. The method of claim 2, wherein the non-alcoholic beverage comprises cold brew coffee.

4. The method of claim 1, wherein the non-alcoholic beverage comprises tea.

5. The method of claim 1, wherein the foaming agent comprises soapbark extract.

6. The method of claim 1, wherein the nitrogen added to the non-alcoholic beverage is in the form of liquid nitrogen.

7. The method of claim 1, further comprising adding at least one of a sweetener, a flavor component, and a dairy component or alternative dairy component to the non-alcoholic beverage.

8. The method of claim 7, wherein the sweetener comprises sugar.

9. The method of claim 7, wherein the flavor component comprises vanilla, a mouthfeel enhancer, or a taste modulator.

10. The method of claim 1, further comprising:
adding a dairy component or alternative dairy component to the non-alcoholic beverage; and
adding a stabilizing agent to the non-alcoholic beverage, the stabilizing agent comprising pectin.

11. The method of claim 1, wherein about 30 g to about 35 g of liquid headspace is left in the widgetless can upon dispensing the non-alcoholic beverage into the widgetless can.

12. A non-alcoholic, nitrogen infused beverage comprising:
a non-alcoholic beverage;
a foaming agent comprising soapbark extract;
carbon dioxide (CO₂); and
nitrogen (N₂), wherein the nitrogen is added to the non-alcoholic beverage in the form of liquid nitrogen.

13. The non-alcoholic, nitrogen infused beverage of claim 12, wherein the non-alcoholic beverage comprises coffee.

14. The non-alcoholic, nitrogen infused beverage of claim 13, wherein the non-alcoholic beverage comprises cold brew coffee.

15. The non-alcoholic, nitrogen infused beverage of claim 12, wherein the non-alcoholic beverage comprises tea.

16. The non-alcoholic, nitrogen infused beverage of claim 12, further comprising at least one of a sweetener, a flavor component, and a dairy component.

17. The non-alcoholic, nitrogen infused beverage of claim 16, wherein the sweetener comprises sugar.

18. The non-alcoholic, nitrogen infused beverage of claim 16, wherein the flavor component comprises vanilla, a mouthfeel enhancer, or a taste modulator.

19. The non-alcoholic, nitrogen infused beverage of claim 12, wherein the ratio of N₂:CO₂ is between about 1:4 and about 4:1.

20. The non-alcoholic, nitrogen infused beverage of claim 12, wherein the ratio of N₂:CO₂ is about 1:1.
